(19) United States
(12) Patent Application Publication
(10) Pub. No.: US 2025/0249534 A1
(43) Pub. Date: Aug. 7, 2025

(54) HYBRID WELDING METHOD

(71) Applicant: HARBIN WELDING INSTITUTE LIMITED COMPANY, Harbin, Heilongjiang (CN)

(72) Inventors: Zhen LEI, Harbin, Heilongjiang (CN); Fujia XU, Harbin, Heilongjiang (CN); Yicheng YANG, Harbin, Heilongjiang (CN); Ruisheng HUANG, Harbin, Heilongjiang (CN); Ziyuan WEN, Harbin, Heilongjiang (CN); Bao JIANG, Harbin, Heilongjiang (CN); Lin LI, Harbin, Heilongjiang (CN); Yandong ZHANG, Harbin, Heilongjiang (CN); Rong LI, Harbin, Heilongjiang (CN)

(21) Appl. No.: 18/832,087

(22) PCT Filed: Nov. 10, 2022
(86) PCT No.: PCT/CN2022/131154

§ 371 Date: Jul. 22, 2024

(30) Foreign Application Priority Data
Oct. 28, 2022 (CN) 202211331243.4

(51) Int. Cl. B23K 26/348

(52) U.S. Cl. CPC B23K 26/348

(57) ABSTRACT

Disclosed is a hybrid welding method. The method includes the following steps: processing form of a groove is determined; defocus amounts and laser powers of leading laser and trailing laser, as well as welding currents and welding speed of leading arc and trailing arc are set; a distance between the leading laser and the leading arc is set, a distance between the trailing laser and the trailing arc is set, and a distance between the leading laser and the trailing laser is set; a time sequence of start-stop signals for devices when a welding trajectory changes is set, start signals for the devices are triggered at a same position, and stop signals are also triggered at a same position; whether the devices are in normal working conditions or not is checked; the devices are turned on to start welding.

### CROSS-REFERENCE TO RELATED APPLICATION

This patent application is a U.S. national stage application of International Patent Application No. PCT/CN2022/131154, filed Nov. 10, 2022, which claims the benefit of and priority to Chinese Patent Application No. 202211331243.4, filed Oct. 28, 2022, each of which is hereby incorporated by reference herein in its entirety.

### TECHNICAL FIELD

The present disclosure relates to the technical field of material processing engineering, in particular to a hybrid welding method.

### BACKGROUND

Compared with single-laser welding and single-arc welding, laser-arc hybrid welding is a high-quality welding technology with low heat input, small welding deformation, and high welding efficiency, and its application scope in engineering field is also increasing. Conventional laser-arc hybrid welding generally refers to the combination of single laser and single arc, the two heat sources work together in a liquid molten pool, and thus have the advantages of fast welding speed and small welding deformation, especially for the welding of a medium-thin plate, reliable single-sided welding and double-sided forming can be easily achieved. At present, when the laser-arc hybrid welding is used to weld a medium-thick plate, high-power laser with the power of over 10,000 watts is combined with electric arc to achieve deep-penetration welding. Generally speaking, with the increase of plate thickness and laser power, the welding reliability and welding quality are getting worse and worse, which not only makes it difficult to obtain reliable single-sided welding and double-sided forming, but also tends to cause defects such as weld porosity, welding cracks, surface splash, and weld undercut, which has become the biggest technical barrier restricting the application and promotion of the laser-arc hybrid welding technology in medium-thick plate welding.

### SUMMARY

A purpose of the present disclosure is to provide a hybrid welding method to solve the problems in the prior art. The hybrid welding method can be used not only for one-time forming welding of a medium-thick plate, but also for multi-layer and multi-pass welding of a thick plate, thus obtaining reliable single-sided welding and double-sided forming.

To achieve the purpose above, the present disclosure provides the following technical solution:

A hybrid welding method is provided by the present disclosure, including the following steps:
Step one: determining processing form of a groove;
Step two: setting defocus amounts and laser powers of leading laser and trailing laser, as well as welding currents and welding speed of leading arc and trailing arc, respectively;
Step three: setting a distance between the leading laser and the leading arc, a distance between the trailing laser and the trailing arc, and a distance between the leading laser and the trailing laser, respectively; the leading arc is located at a front end of an irradiation area of the leading laser, and the trailing arc is located at a rear end of an irradiation area of the trailing laser;
Step four: setting a time sequence of start-stop signals for a leading laser device, a leading arc welding device, a trailing laser device, and a trailing arc welding device when a welding trajectory changes, start signals for the leading laser device, the leading arc welding device, the trailing laser device, and the trailing arc welding device are triggered at a same position, and stop signals are also triggered at a same position;
Step five: checking whether the leading laser device, the leading arc welding device, the trailing laser device, the trailing arc welding device, a preheating device, and a controlled cooling device are in normal working conditions or not; and
Step six: turning on the devices to start welding.

Alternatively, in Step two, in a case that beams are required to swing, setting swing parameters of the leading laser and the trailing laser, respectively, the swing parameters include swing frequencies, swing amplitudes, and swing directions of the leading laser and the trailing laser. Beam swing functions of the leading laser and the trailing laser are independently controlled, beams can swing at certain frequencies and swing amplitudes, and can be set as swing welding or non-swing welding as required. In the present disclosure, the beams are limited to swing at certain frequencies and swing amplitudes, and are adjusted adaptively according to changes of a groove gap. In the swing welding mode, the swing amplitude and laser power of the beam of the leading laser can be adjusted adaptively according to changes of the groove gap, so as to ensure reliable penetration of a side wall and root of a backing weld seam. The swing amplitude of the trailing laser is relatively large to prevent the side wall from lack-of-fusion and ensure the welding quality of a cap weld seam.

Alternatively, the leading laser and the trailing laser are serially arranged in a welding direction, the leading laser is combined with the leading arc at a foremost end in the welding direction, and a formed weld bead is collectively called a backing weld bead, which is required to form a root penetration welding, so the power of the leading laser is high. The trailing laser is combined with the trailing arc at a rearmost end in the welding direction, and a formed weld bead is called a filling weld bead or a cap weld bead according to the form of the groove, the required laser power is relatively low, which is mainly used to achieve coupling with an arc heat source, so as to increase arc stability and prevent defects such as lack-of-fusion. The welding method can be used not only for one-time forming welding of a medium-thick plate, but also for multi-layer and multi-pass welding of a thick plate. A liquid molten pool formed by melting a welding wire and base metal with the leading arc has good bridging ability, and can achieve high-quality backing welding under complex working conditions of large misalignment and large gap, so as to improve the adaptability of the backing welding process to the working conditions of misalignment and gap. The power of the trailing arc is relatively high, so as to obtain higher deposited metal to achieve efficient cap filling. In the above different welding applications, the laser and arcs at different positions play different roles.

Alternatively, the leading arc is a gas tungsten arc welding arc or a single-wire gas metal arc welding arc. The trailing arc is a single-wire gas metal arc welding arc or a double-wire gas metal arc welding arc.

Alternatively, the distance between the leading arc and the leading laser is 1-20 mm, the distance between the trailing laser and the trailing arc is 1-10 mm, and the distance between the leading laser and the trailing laser is 10-400 mm.

Alternatively, the swing frequencies of the leading laser and the trailing laser are 0-300 Hz, and the swing amplitudes of the leading laser and the trailing laser are 0-10 mm.

In the multi-layer and multi-pass welding process of a thick plate workpiece: (1) requirements for the backing welding process are the same as above. (2) In the multi-pass filling welding process, the laser powers of both the leading laser and the trailing laser are relatively low, and when two lasers are coupled with two arcs, respectively, the stability of the arcs is significantly improved, and the swing amplitudes of both the two lasers are relatively large, so as to obtain reliable weld seam fusion quality and prevent welding from defects such as lack-of-fusion. (3) The arc powers of both the two arcs are selected to be relatively high, so as to obtain a relatively high deposition efficiency, thus achieving efficient filling.

By cooperatively controlling the laser powers of the two beams, laser-wire distances and arc parameters in the welding process, the flow process of the liquid molten pool can be stably controlled, and thus the excess height and width of the front and back of the weld seam can be reliably adjusted. In terms of spatial layout, the distance L1 between the leading arc and the leading laser is set within a range of 1-20 mm, the distance L2 between the trailing laser and the trailing arc is set within a range of 1-10 mm, and the distance L0 between the leading laser and the trailing laser is 10-400 mm. According to methods for solving the problem, the thermal cycle of the weld seam can be accurately adjusted by adjusting the distances between heat sources and providing appropriate process parameters. The process parameters include current of the leading arc, current of the trailing arc, power of the leading laser, power of the trailing laser, and the distances between hybrid heat sources.

Compared with the prior art, the present disclosure achieves the following technical effects.

Compared with the traditional laser-arc hybrid welding, the method in the present disclosure has higher welding efficiency and more reliable welding quality, and can achieve single-sided welding and double-sided forming at one time in a single pass. A thickness of a weldable workpiece is increased by 50%, and the metal deposition efficiency is increased by 2-3 times. Especially when a structural part with a thickness of 10-30 mm is welded, a reliable single-sided welding and double-sided forming can be achieved. In the present disclosure, by adjusting welding process parameters, single-sided welding and double-sided forming can be achieved, the requirement for single-sided one-time welding forming of a thick plate is satisfied, and the investment cost of the device is significantly reduced. In terms of technology route, in the present disclosure, the leading arc of is a gas tungsten arc welding arc or a single-wire gas metal arc welding arc, which can effectively ensure the adaptability to working conditions, and meanwhile, metal can be added to better control the formation of the back of the weld seam. The adaptability to the groove gap, misalignment and other working conditions during backing welding can be significantly improved through the self-flowing filling of the liquid metal formed by the leading arc and the adaptive control of the leading laser according to the groove gap, and thus the welding quality of a backing layer is improved. By cooperatively controlling the heat inputs of two lasers and two arcs, the distance L1 between the leading laser and the leading arc, the distance L2 between the trailing laser and the trailing arc, the distance L0 between the leading laser and the trailing laser, and the welding speed, the non-preheating welding of high-strength steel can be achieved.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those skilled in the art may still derive other drawings from these accompanying drawings without creative efforts.

FIG. 1 is a schematic diagram of a welding process of a hybrid welding method according to the present disclosure.

In the drawings: 1 leading laser; 2 trailing laser; 3 leading laser focusing mirror; 4 trailing laser focusing mirror; 5 leading arc welding torch; 6 trailing arc welding torch; 7 leading arc; 8 trailing arc; 9 substrate.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

A purpose of the present disclosure is to provide a hybrid welding method to solve the problems in the prior art. The hybrid welding method can be used not only for one-time forming welding of a medium-thick plate, but also for multi-layer and multi-pass welding of a thick plate, thus obtaining reliable single-sided welding and double-sided forming.

In order to make the purpose, features and advantages of the present disclosure more clearly, the present disclosure is further described in detail below with reference to the embodiments.

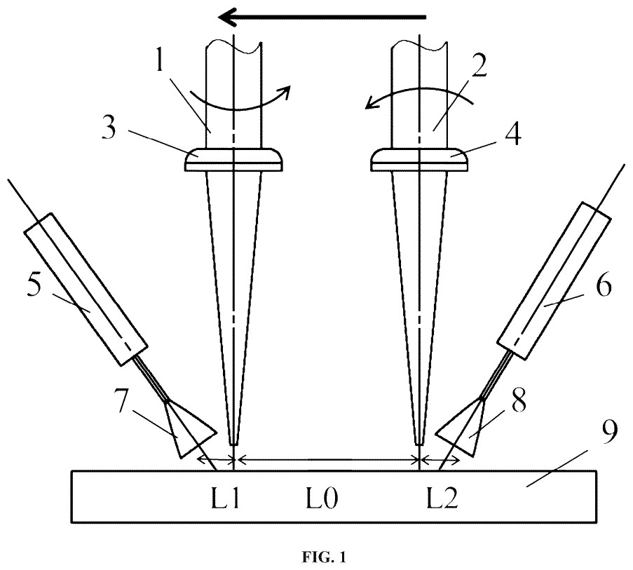

A hybrid welding method is provided by the present disclosure, including the following steps:
Step one, according to specific welding technical requirements, processing form of a groove of a substrate 9 is determined according to laser power and arc filling ability.
Step two, a defocus amount f1 of a leading laser 1 and a defocus amount f2 of a trailing laser 2, as well as laser powers P1 and P2 of two beams of the leading laser and the trailing laser are set, respectively. In a case that the beams are required to swing, swing parameters include swing frequencies F1 and F2, swing amplitudes D1 and D2, swing directions of the two beams, welding currents A1 and A2 of a leading arc 7 and a trailing arc 8, and welding speed V.
Step three, a distance L1 between the leading laser 1 and the leading arc 7, a distance L2 between the trailing laser 2 and the trailing arc 8, and a distance L0 between the leading laser 1 and the trailing laser 2 are set, respectively.
Step four, according to features of a welding sample piece, a time sequence of start-stop signals for a leading laser device, a leading arc welding device, a trailing laser device, and a trailing arc welding device when a welding trajectory changes is set. Start signals for the leading laser device, the leading arc welding device, the trailing laser device, and the trailing arc welding device are triggered at a same position, and stop signals are also triggered at a same position. The leading laser device includes a leading laser focusing mirror 3, the trailing laser device includes a trailing laser focusing mirror 4, the leading arc welding device includes a leading arc welding torque 5, and the trailing arc welding device includes a trailing arc welding torque 6.
Step five, whether the laser devices, a secondary welding gun device, a main welding gun device, a preheating device, and a controlled cooling device are in normal working conditions or not is checked.
Step six, the devices are turned on to start welding. Welding state is as shown in FIG. 1, and a horizontal arrow direction in FIG. 1 represents a welding direction.

### Embodiment 1

Based on the technical points of this method, a Q1100 high-strength steel welding test plate with a thickness of 20 mm is used as an example for illustration. The specific size of a single test plate is 1000*400*20 mm, the grade of a welding wire used is ER120S-G, and it is required that there are no obvious defects such as cracks and porosity after welding, so as to achieve single-sided welding and double-sided forming. According to this technical requirement, the specific welding operation steps are as follows.
Step one: according to specific welding technical requirements, with maximum output powers of two lasers being 30 kW and 6 kW, respectively, a groove of a weld seam is set to be Y-shaped, a thickness of a blunt edge is set to be 12 mm, and a bilateral angle is set to be 40°.
Step two: a defocus amount f1 of a leading laser 1 is set to be −3 mm, and a defocus amount of a trailing laser 2 is set to be +8 mm; a swing frequency F1 of the leading laser 1 is set to be 50 Hz, and a swing frequency F2 of the trailing laser 2 is set to be 300 HZ; a swing amplitude D1 of the leading laser 1 is set to be 2 mm, and a swing amplitude D2 of the trailing laser 2 is set to be 5 mm. Forward swing is set as a swing direction of the leading laser 1, and a reverse swing is set as a swing direction of the trailing laser 2; output laser power P1 of the leading laser 1 is set to be 8 KW, and output laser power P2 of the trailing laser 2 is set to be 2 kW; welding current A1 of a leading arc 7 is set to be 240 A, and welding current A2 of a trailing arc 8 is set to be 270 A; and welding speed V is set to be 0.8 m/min.
Step three: a distance L1 between the leading laser 1 and the leading arc 7 is set to be 4 mm, a distance L2 between the trailing laser 2 and the trailing arc 8 is set to be 6 mm, and a distance L0 between the leading laser 1 and the trailing laser 2 is set to be 40 mm.
Step four: according to features of a welding sample piece, start-stop signals for a leading laser device, a leading arc welding device, a trailing laser device, and a trailing arc welding device when a welding trajectory changes are set, respectively. Start signals of the leading laser device, the leading arc welding device, the trailing laser device, and the trailing arc welding device are triggered at a same position, and stop signals are also triggered at a same position.
Step five: whether the laser devices, a secondary welding gun device, a main welding gun device, a preheating device, and a controlled cooling device are in normal working conditions or not is checked.
Step six: the devices are turned on to start welding.

For the Q1100 high-strength steel with the thickness of 20 mm, in conventional arc or laser-arc hybrid welding methods, multi-pass and multi-layer welding are required, leading to low welding efficiency. In the method of the present disclosure, the single-sided welding and double-sided forming process control of the material with such a thickness can be completed by one-time welding, and the welding efficiency is increased by 2.5 times and more. Moreover, in the past welding process, such a material is required preheating before welding, which increases not only the difficulty of welding process control but also the welding cost. In the method of the present disclosure, the thermal cycle during the welding process can be accurately adjusted through the combination adjustment of the distance between the leading laser 1 and the leading arc 7, the distance between the trailing laser 2 and the trailing arc 8, and the distance between the two lasers and the back laser beam, and crack-free and high-quality welding can be achieved without complicated preheating process.

### Embodiment 2

A Q960E high-strength steel T-shaped welding sample piece with a large thickness is used as an example for illustration, size of a vertical plate of the sample piece is 1000*500*50 mm, size of a flat plate is 1000*400*40 mm. The grade of a welding wire used for the leading arc is ER100S-G, and the grade of a welding wire used for the trailing arc is E120S-G. It is required that there are no obvious defects such as porosity, cracks, and undercuts in the welding structure. Size of a fillet weld is 15 mm. Double-sided welding method is used for welding. According to the technical requirements, the specific welding operation steps are as follows.
Step one: according to specific welding technical requirements, maximum output power of a laser for the leading laser 1 is 20 kW, and maximum output power of a laser for the trailing laser 2 is 6 kW. No groove is processed for a weld seam, an included angle between a welding gun and a horizontal workpiece is 45°, and an included angle between a laser gun and a horizontal direction is 30°.
Step two: a defocus amount f1 of a leading laser 1 is set to be 0 mm, a defocus amount f2 of a trailing laser 2 is set to be +5 mm. Single-laser non-swing welding mode is used for the leading laser 1. A swing frequency F2 of the trailing laser 2 is set to be 300 HZ, a swing amplitude D2 of the trailing laser 2 is set to be 8 mm, and the trailing laser 2 swings clockwise along a welding direction. A output laser power P1 of the leading laser 1 is set to be 15 KW, a output laser power P2 of the trailing laser 2 is set to be 5 KW, a welding current A1 of a leading arc 7 is set to be 160 A, a welding current A2 of a trailing arc 8 is set to be 280 A, and a welding speed V is set to be 1.2 m/min.
Step three: a distance L1 between the leading laser 1 and the leading arc 7 is set to be 3 mm, a distance L2 between the trailing laser 2 and the trailing arc 8 is set to be 5 mm, and a distance L0 between the leading laser 1 and the trailing laser 2 is set to be 80 mm.
Step four: according to features of the welding sample piece, start-stop signals for a leading laser device, a leading arc welding device, a trailing laser device, and a trailing arc welding device when a welding trajectory changes are set, respectively. Start signals for the leading laser device, the leading arc welding device, the trailing laser device, and the trailing arc welding device are triggered at a same position, and stop signals are also triggered at a same position.
Step five: whether the laser devices, a secondary welding gun device, a main welding gun device, a preheating device, and a controlled cooling device are in normal working conditions or not is checked.
Step six: the devices are turned on to start welding at one side.
Step seven: after the welding on one side is completed, the workpiece is overturned, and Step four to Step six are repeated to complete the welding of the whole workpiece.

The technical problems such as large welding deformation, low welding efficiency, and multiple internal defects in multi-pass and multi-layer welding seams of Q960E high-strength steel T-shaped joint can be solved by the proposed double-beam scanning laser-arc hybrid welding method, in which only two-pass doubled-sided welding on both sides is required. Compared with traditional arc welding technology, preheating is not required in this method, the weld seam is crack-free, the welding efficiency is increased by 600%, the porosity in the weld seam is decreased by 87%, and there are no defects such as interlayer lack-of-fusion.

In the description of the present disclosure, it needs to be understood that the orientation or positional relationship indicated by terms “center”, “top”, “bottom”, “left”, “right”, “vertical”, “horizontal”, “inside” and “outside” is based on the orientation or positional relationship shown in the drawings only for convenience of description of the present disclosure and simplification of description rather than indicating or implying that the apparatus or element referred to must have a particular orientation, be constructed and operate in a particular orientation, and thus are not to be construed as limiting the present disclosure. Furthermore, the terms “first” and “second” are used for descriptive purposes only and are not to be construed as indicating or implying relative importance.

Specific examples are used herein for illustration of the principles and implementations of the present disclosure. The description of the above-mentioned embodiments is merely used to help illustrate the method and its core principles of the present disclosure. In addition, those skilled in the art can make various modifications to the specific embodiments and scope of application in accordance with the teachings of the present disclosure. In conclusion, the content of this specification shall not be construed as a limitation to the present disclosure.

1. A hybrid welding method, comprising the following steps:
Step one: determining processing form of a groove;
Step two: setting defocus amounts and laser powers of leading laser and trailing laser, as well as welding currents and welding speed of leading arc and trailing arc, respectively;
Step three: setting a distance between the leading laser and the leading arc, a distance between the trailing laser and the trailing arc, and a distance between the leading laser and the trailing laser, respectively;
Step four: setting a time sequence of start-stop signals for a leading laser device, a leading arc welding device, a trailing laser device, and a trailing arc welding device when a welding trajectory changes, wherein start signals for the leading laser device, the leading arc welding device, the trailing laser device and the trailing arc welding device are triggered at a same position, and stop signals are also triggered at a same position;
Step five: checking whether the leading laser device, the leading arc welding device, the trailing laser device, the trailing arc welding device, a preheating device, and a controlled cooling device are in normal working conditions or not; and
Step six: turning on the devices to start welding.

2. The hybrid welding method according to claim 1, wherein in Step two, in a case that beams are required to swing, setting swing parameters of the leading laser and the trailing laser, respectively, wherein the swing parameters comprise swing frequencies, swing amplitudes, and swing directions of the leading laser and the trailing laser.

3. The hybrid welding method according to claim 1, wherein the leading laser and the trailing laser are serially arranged in a welding direction, the leading laser is combined with the leading arc at a foremost end in the welding direction, and the trailing laser is combined with the trailing arc at a rearmost end in the welding direction.

4. The hybrid welding method according to claim 1, wherein the leading arc is a gas tungsten arc welding arc or a single-wire gas metal arc welding arc; the trailing arc is a single-wire gas metal arc welding arc or a double-wire gas metal arc welding arc.

5. The hybrid welding method according to claim 1, wherein the distance between the leading arc and the leading laser is 1-20 mm, the distance between the trailing laser and the trailing arc is 1-10 mm, and the distance between the leading laser and the trailing laser is 10-400 mm.

6. The hybrid welding method according to claim 2, wherein the swing frequencies of the leading laser and the trailing laser are 0-300 Hz, and the swing amplitudes of the leading laser and the trailing laser are 0-10 mm.
